(19) United States
(12) Patent Application Publication
(10) Pub. No.: US 2017/0349008 A1
(43) Pub. Date: Dec. 7, 2017

(54) Spare Tire Assembly

(71) Applicant: Rudy Garcia, Houston, TX (US)

(72) Inventor: Rudy Garcia, Houston, TX (US)

(21) Appl. No.: 15/175,203

(22) Filed: Jun. 7, 2016

(51) Int. Cl. B60C 17/06

(52) U.S. Cl. CPC B60C 17/06; B60C 2017/063

(57) ABSTRACT

A spare tire assembly for pre-installation in tires to protect tires when flattened includes an insert that is resilient. The insert is toroidally shaped and defines a central opening. The central opening is complementary to a rim of a wheel, such that the insert is positionable between the rim and a tire that is to be coupled to the rim. A cover is positioned over an outer surface of the insert. The cover is configured to shield the insert from potential damage as the wheel rotates with the tire in a deflated condition. A user is able to operate a vehicle having a flattened tire that is configured with the insert for a period of time without damaging the flattened tire.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to spare tire assemblies and more particularly pertains to a new spare tire assembly for pre-installation in tires to protect tires when flattened.

### BRIEF SUMMARY OF THE INVENTION

An embodiment of the disclosure meets the needs presented above by generally comprising an insert that is resilient. The insert is toroidally shaped and defines a central opening. The central opening is complementary to a rim of a wheel, such that the insert is positionable between the rim and a tire that is to be coupled to the rim. A cover is positioned over an outer surface of the insert. The cover is configured to shield the insert from potential damage as the wheel rotates with the tire in a deflated condition. A user is able to operate a vehicle having a flattened tire that is configured with the insert for a period of time without damaging the flattened tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a spare tire assembly according to an embodiment of the disclosure.

FIG. 2 is an in-use view of an embodiment of the disclosure.

FIG. 3 is cross-sectional view of an embodiment of the disclosure.

FIG. 4 is a cross-sectional view of an embodiment of the disclosure.

### DETAILED DESCRIPTION OF THE INVENTION

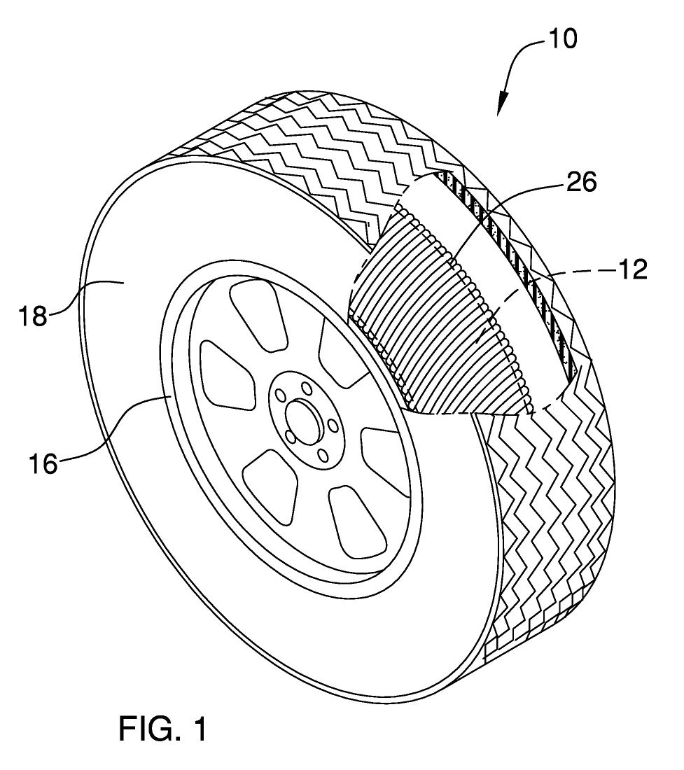

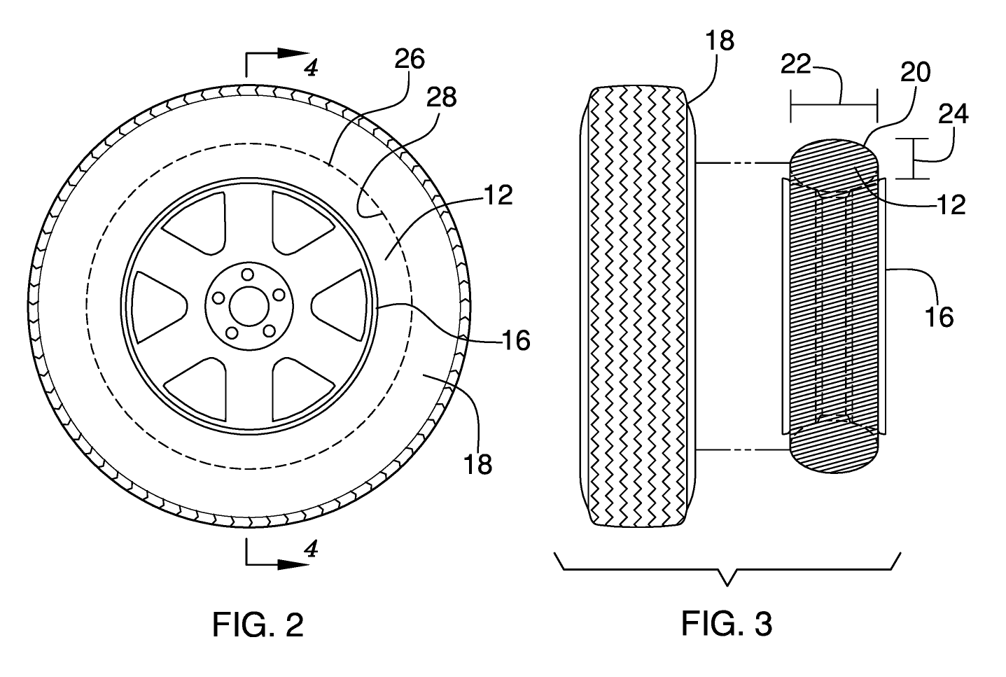

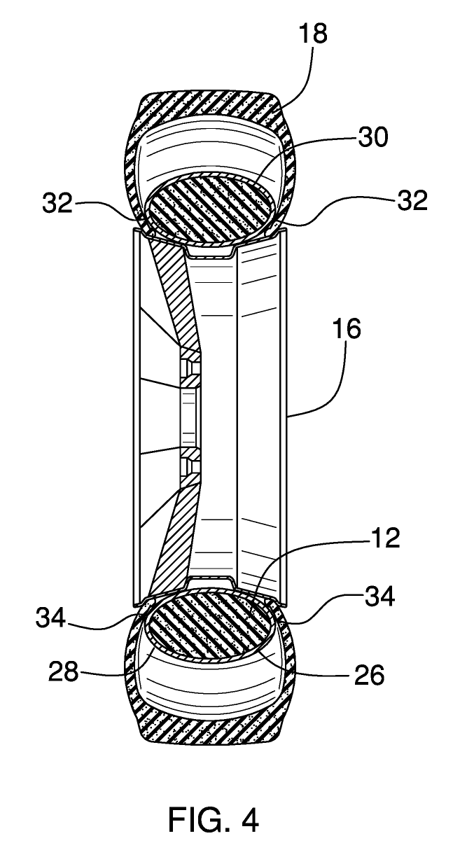

With reference now to the drawings, and in particular to FIGS. 1 through 4 thereof, a new spare tire assembly embodying the principles and concepts of an embodiment of the disclosure and generally designated by the reference numeral 10 will be described.

As best illustrated in FIGS. 1 through 4, the spare tire assembly 10 generally comprises an insert 12 that is resilient. The insert 12 is toroidally shaped defining a central opening 14. The central opening 14 is complementary to a rim 16 of a wheel. The insert 12 is positionable between the rim 16 and a tire 18 that is to be coupled to the rim 16. The insert 12 has a cross-section 20. The cross-section 20 has a long axis 22 and a short axis 24, such that the cross-section 20 is ovally shaped. The long axis 22 of the cross-section 20 is substantially equivalent to a width of the rim 16. In one embodiment, the insert 12 comprises rubber. In another embodiment, the insert 12 comprises vinyl. In yet another embodiment, the insert 12 comprises rubber and vinyl.

A cover 26 is positioned over an outer surface 28 of the insert 12. The cover 26 is positioned over the outer surface 28 such that the cover 26 is configured to shield the insert 12 from potential damage as the wheel rotates with the tire 18 in a deflated condition. The cover 26 comprises metal. In one embodiment, the cover 26 comprises steel. In another embodiment, the cover 26 comprises a wire 30 that is coiled around the insert 12. In yet another embodiment, the wire 30 comprises braided steel cable.

The assembly 10 also may comprise a pair of fasteners 32. Each fastener 32 is coupled to a respective opposing side 34 of the cover 26. The fasteners 32 are positioned on the cover 26 such that the fasteners 32 are configured to couple to the tire 18. The fasteners 32 comprise adhesive.

In use, the insert 12 is positionable between the rim 16 and a tire 18 that is to be coupled to the rim 16. The cover 26 is positioned over the outer surface 28 of the insert 12 such that the cover 26 is configured to shield the insert 12 from potential damage as the wheel rotates with the tire 18 in a deflated condition. The user is able to operate a vehicle has a flattened tire that is configured with the insert 12 to a period of time without damaging the flattened tire.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A spare tire assembly comprising:
an insert, said insert being resilient, said insert being toroidally shaped defining a central opening, said central opening being complementary to a rim of a wheel, wherein said insert is positionable between the rim and a tire that is to be coupled to the rim;
a cover positioned over an outer surface of said insert, wherein said cover is positioned over said outer surface such that said cover is configured to shield said insert from potential damage as the wheel rotates with the tire in a deflated condition; and
wherein said insert is positionable between the rim and a tire that is to be coupled to the rim, wherein said cover is positioned over said outer surface such that said cover is configured to shield said insert from potential damage as the wheel rotates with the tire in a deflated condition, such that a user is able to operate a vehicle having a flattened tire that is configured with said insert for a period of time without damaging the flattened tire.

2. The assembly of claim 1, further including said insert having a cross-section, said cross-section having a long axis and a short axis such that said cross-section is ovally shaped, wherein said long axis of said cross-section is substantially equivalent to a width of the rim.

3. The assembly of claim 1, further including said insert comprising rubber.

4. The assembly of claim 1, further including said insert comprising vinyl.

5. The assembly of claim 4, further including said insert comprising rubber and vinyl.

6. The assembly of claim 1, further including said cover comprising metal.

7. The assembly of claim 6, further including said cover comprising steel.

8. The assembly of claim 1, further including said cover comprising a wire coiled around said insert.

9. The assembly of claim 8, further including said wire comprising braided steel cable.

10. The assembly of claim 1, further including a pair of fasteners, each said fasteners being coupled to a respective opposing side of said cover, wherein said fasteners are positioned on said cover such that said fasteners are configured to couple to the tire.

11. The assembly of claim 10, further including said fasteners comprising adhesive.

12. A spare tire assembly comprising:
an insert, said insert being resilient, said insert being toroidally shaped defining a central opening, said central opening being complementary to a rim of a wheel, wherein said insert is positionable between the rim and a tire that is to be coupled to the rim, said insert having a cross-section, said cross-section having a long axis and a short axis such that said cross-section is ovally shaped, wherein said long axis of said cross-section is substantially equivalent to a width of the rim, said insert comprising rubber, said insert comprising vinyl, said insert comprising rubber and vinyl;
a cover positioned over an outer surface of said insert, wherein said cover is positioned over said outer surface such that said cover is configured to shield said insert from potential damage as the wheel rotates with the tire in a deflated condition, said cover comprising metal, said cover comprising steel, said cover comprising a wire coiled around said insert, said wire comprising braided steel cable;
a pair of fasteners, each said fasteners being coupled to a respective opposing side of said cover, wherein said fasteners are positioned on said cover such that said fasteners are configured to couple to the tire, said fasteners comprising adhesive; and
wherein said insert is positionable between the rim and a tire that is to be coupled to the rim, wherein said cover is positioned over said outer surface such that said cover is configured to shield said insert from potential damage as the wheel rotates with the tire in a deflated condition, such that a user is able to operate a vehicle having a flattened tire that is configured with said insert for a period of time without damaging the flattened tire.
